(19) United States
(12) Patent Application Publication
(10) Pub. No.: US 2007/0277028 A1
(43) Pub. Date: Nov. 29, 2007

(54) Method and system for recovery from reprogramming failures in nonvolatile memory

(76) Inventors: Jamey Cates, Ann Arbor, MI (US); Matthew William Higgins, Saline, MI (US)

Correspondence Address: MERCHANT & GOULD PC, P.O. BOX 2903, MINNEAPOLIS, MN, 55402-0903, US

(21) Appl. No.: 11/441,706

(22) Filed: May 26, 2006

(51) Int. Cl. G06F 9/00

(52) U.S. Cl. 713/2

(57) ABSTRACT

A method of reprogramming a nonvolatile memory is disclosed. The nonvolatile memory includes a plurality of sectors, including a backup sector. The method includes saving original backup sector memory contents of a backup sector. The method further includes storing a boot sequence in the backup sector. The method also includes designating the backup sector as a valid boot sector. The method includes reprogramming at least one sector in the nonvolatile memory that is separate from the backup sector. The method includes designating a sector separate from the backup sector as a valid boot sector. The method further includes storing the original backup sector memory contents in the backup sector.

### TECHNICAL FIELD

The present invention relates generally to programming of memory systems. More specifically, the present invention relates to methods and systems for recovery from reprogramming failures in nonvolatile memory.

### BACKGROUND

Computing systems, including both embedded systems and stand-alone computing systems, generally include a nonvolatile memory, such as a read-only memory (ROM), flash memory, or other electrically programmable read only memory (EPROM) or electrically erasable and programmable read only memory (EEPROM) device. The memory for such a computing system generally includes a boot sector memory, which contains an instruction set, or boot sequence, used by a processing unit to initialize components of the computing system. The boot sequence generally also includes a bootstrap instruction to the processing unit, which points the processing unit to a location in memory known to be the initial processing location in non-boot memory at which instruction processing begins. By sector, it is intended that a discrete subset of the memory subsystem is contemplated. The sector may or may not include continuous memory addresses or contiguous memory locations.

The boot sector memory may need to be updated during the life of the computing system in which it is located. For example, changes in the circuit or peripheral components to which the computing system is interfaced could affect the instantiation sequence for the system. Or, changed non-boot sector programming could affect the location to which the bootstrap instruction points.

Various methods of updating memory are anticipated, such as via physical replacement of a non-programmable ROM chip placed in a socket arrangement, or providing the ability to reprogram the memory, such as in a flash-ROM chip. In a reprogrammable memory such as a flash-ROM, failures can occur during the programming process due to faulty data transmission, storage, or external factors such as a power failure or other interruption. When such failures occur in a boot sector of the system, the failure can corrupt the boot sequence and can cause a “brain dead” state in which no recovery of the computing system is possible. This can cause the entire computing system to be rendered unusable.

Systems that attempt to mitigate this risk may store separate copies of the boot sector code elsewhere in memory before attempting to reprogram the boot sector memory. These systems require that additional memory be permanently allocated to provide a backup boot sector instruction set.

Other systems include a storage system for mitigation steps aimed to reduce the chance of boot sequence corruption. These systems reduce the possibility of data corruption in the boot sector, but do not eliminate the possibility that errors could occur due to external occurrences such as power outages or other unpredicted failures.

For these and other reasons, improvements are desirable.

### SUMMARY

The above and other problems are solved in accordance with the present disclosure by the following:

In one aspect, a method of reprogramming a nonvolatile memory having a plurality of sectors, including a backup sector, is disclosed. The method includes saving original backup sector memory contents of a backup sector. The method further includes storing a boot sequence in the backup sector. The method also includes designating the backup sector as a valid boot sector. The method includes reprogramming at least one sector in the nonvolatile memory that is separate from the backup sector. The method includes designating a sector separate from the backup sector as a valid boot sector. The method further includes storing the original backup sector memory contents in the backup sector.

In a second aspect, a system for reprogramming a nonvolatile memory is disclosed. The system includes an electronic control unit and a reprogramming system electrically connected to the electronic control unit. The electronic control unit includes a nonvolatile memory including a plurality of sectors, the plurality of sectors including a backup sector. The electronic control unit also includes a programmable circuit electrically connected to the nonvolatile memory and configured to initialize by accessing a boot sector in the nonvolatile memory. The reprogramming system is electrically connected to the electronic control unit. The reprogramming system is configured to save original backup sector memory contents of a backup sector. The reprogramming system is also configured to store a boot sequence in the backup sector. The reprogramming system is further configured to designate the backup sector as a valid boot sector. The reprogramming system is configured to reprogram at least one sector in the nonvolatile memory, where the at least one sector is separate from the backup sector. The reprogramming system is also configured to designate a sector separate from the backup sector as a valid boot sector. The reprogramming system is also configured to store the original backup sector memory contents in the backup sector.

According to a third aspect, a method of reprogramming a boot sequence in a nonvolatile memory is disclosed. The method includes saving an original backup sector memory image from a backup sector. The method also includes, upon saving the original backup sector memory image, erasing the contents of the backup sector. The method further includes storing a boot sequence in the backup sector. The method also includes designating the backup sector as a valid boot sector. The method includes designating an original boot sector in the nonvolatile memory as an invalid boot sector. The method additionally includes reprogramming the original boot sector with a new boot sequence. The method includes designating the original boot sector as a valid boot sector. The method includes designating the backup sector as an invalid boot sector. The method further includes storing the original backup sector memory image in the backup sector.

### BRIEF DESCRIPTION OF THE DRAWINGS

FIG. 1 is a block diagram of systems and methods of recovery from reprogramming failures in nonvolatile memory according to aspects of the present disclosure;

FIG. 2 is a block diagram of a generalized electronic control unit used to implement aspects of the present disclosure;

FIG. 3 illustrates the logical organization of memory sector in a memory subsystem used in an example embodiment of the present disclosure;

FIG. 4 illustrates the logical organization of a memory subsystem used in an example embodiment of the present disclosure;

FIG. 5A is a block diagram of an electronic control unit showing a memory subsystem in which aspects of the present disclosure can be implemented;

FIG. 5B is a block diagram of an electronic control unit showing a memory subsystem in which aspects of the present disclosure can be implemented;

FIG. 6A is a block diagram of a memory reprogramming system used with a control unit according to an example embodiment of the present disclosure;

FIG. 6B is a block diagram of a memory reprogramming system used with a control unit according to an example embodiment of the present disclosure;

FIG. 7 is a flow diagram of failure determination aspects of methods and systems for recoverable reprogramming of a nonvolatile memory according to an example embodiment of the present disclosure;

FIG. 8 is a block diagram of a system for recoverable reprogramming of a nonvolatile memory according to an example embodiment of the present disclosure; and

FIG. 9 is a schematic representation of a computing system that may be used to implement aspects of the present disclosure.

### DETAILED DESCRIPTION

The present disclosure relates generally to methods and systems for recovery from reprogramming failures in nonvolatile memory. These methods are applicable to many different types of embedded and stand-alone computing systems in various industries, and provide additional fault tolerance while promoting efficient memory management.

As referred to herein, nonvolatile memory refers to various types of memory systems and components that do not need to have their memory contents periodically refreshed. This includes all forms of read-only memory (ROM) such as programmable read-only memory (PROM), erasable programmable read-only memory (EPROM), electrically erasable programmable read-only memory (EEPROM), and flash memory. Nonvolatile memory can also include random access memory that is powered with a battery.

In many systems, memory access occurs on a per sector basis. In the systems as described herein, a memory subsystem is primarily described as being accessed on both a data word level (usually 4 bytes, or 32 bits) and a sector level basis. Although per sector access is described, it is understood that the present disclosure contemplates memory access of both sector-level access as well as memory access processes of both coarser and finer granularity, such as using a word-access, half-word access, or byte access memory subsystem.

The programmable circuit as referred to herein can include a processor, such as an embedded processing unit or socketed processor. The programmable circuit can include any other type of circuit configuration capable of executing an instruction set language, such as can be configured in various types of programmable logic arrays (PLAs) or programmable logic devices (PLDs).

As referred to herein, storing and restoring refer to processes of programming the nonvolatile memory with data. Saving, similarly, refers to placing data in a memory, which could include storing the data in nonvolatile memory, or holding the data in an external memory, such as a RAM, ROM, or other memory.

The methods and systems for reprogramming nonvolatile memory include saving original backup sector memory contents of a backup sector. The methods and systems further include storing a boot sequence in the backup sector. The methods and systems also include designating the backup sector as a valid boot sector. The methods and systems include reprogramming at least one sector in the nonvolatile memory that is separate from the backup sector, and further include designating a sector separate from the backup sector as a valid boot sector. The methods and systems also include storing the original backup sector memory contents in the backup sector.

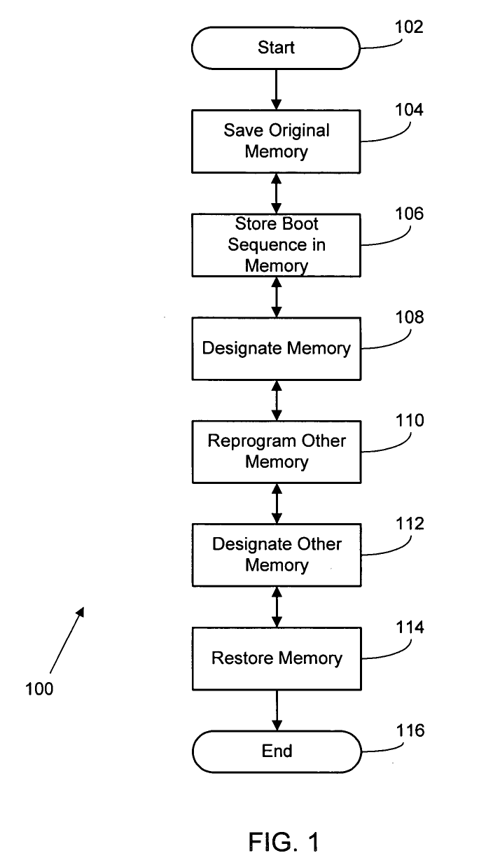

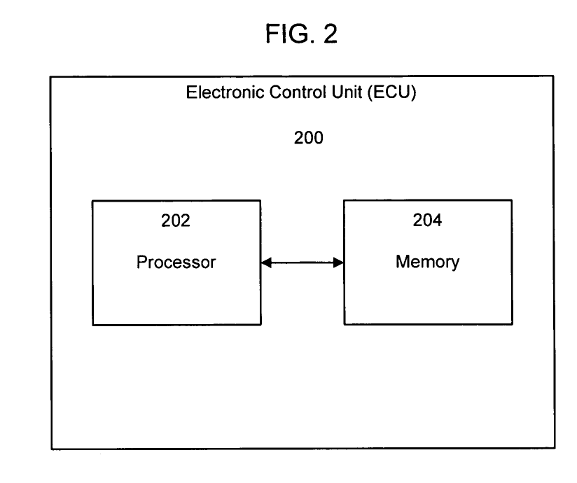

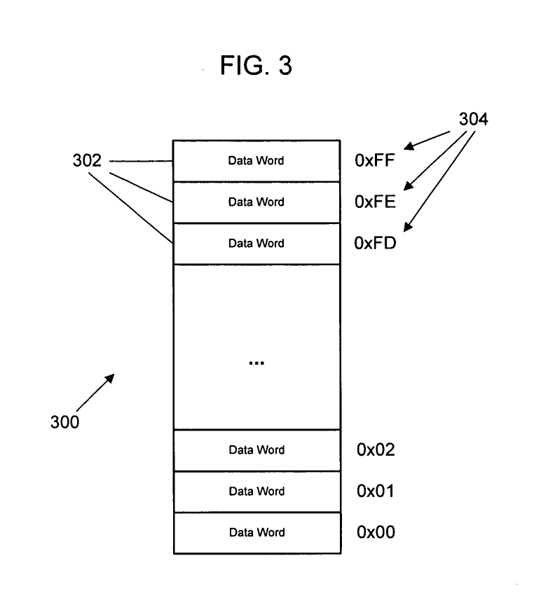

Referring now to FIG. 1, a block diagram of systems and methods of recovery from reprogramming failures in nonvolatile memory is shown according to aspects of the present disclosure. The system 100 shown is generally configured to provide a failsafe methodology for programming of nonvolatile memory in a memory subsystem, such as those shown and described below in FIGS. 2-3. It is assumed in the system 100 that a programmable circuit, such as a processor, is interfaced with a memory subsystem including an original boot memory from which programmable circuit operation is initialized. Generally, a boot memory provides initialization of various registers, environmental parameters, self-tests, or other functionality used to prepare the system for operation. The boot memory generally includes a bootstrap instruction configured to point the programmable circuit to a location where program code begins.

The system 100 is instantiated at a start operation 102. Operational flow proceeds to a save module 104. The save module 104 saves original memory contents, which are stored in a backup sector. The backup sector is to be used as an alternative boot sector in a memory subsystem as described below in FIGS. 2-3. For example, the backup sector, or alternative boot sector, can be a memory sector located in an area of the memory subsystem traditionally reserved for data storage, but will be reserved as an alternative boot location during the reprogramming process.

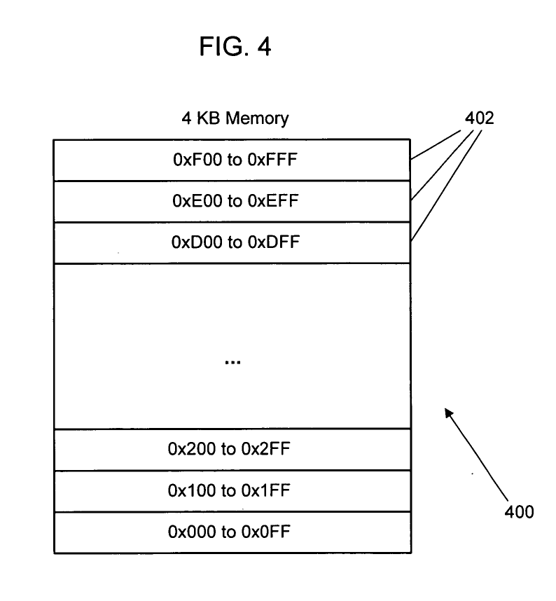

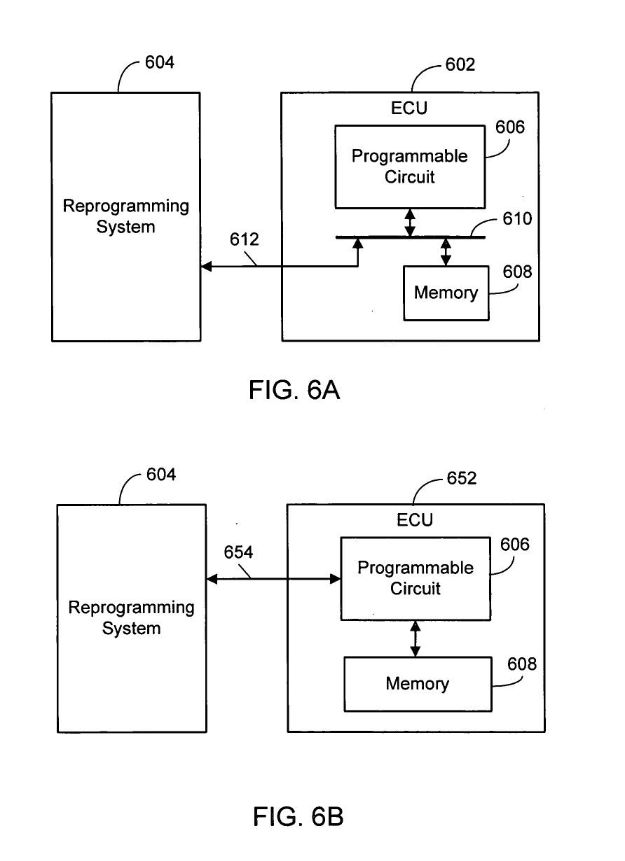

The save module 104 can be performed by a reprogramming system, such as the reprogramming systems described below in connection with FIGS. 6A-6B. The reprogramming system can be interfaced to the memory subsystem, which includes the nonvolatile memory to be reprogrammed, via a system bus, or using a programming circuit or other intermediary processing unit, as shown below. The save module 104 is generally configured to save memory from a nonvolatile memory location, rather than a power-dependent, or volatile, memory such as random access memory. In various embodiments, the original memory contents from the backup sector are stored either in the reprogramming system itself or in a memory interfaced to the reprogramming system (not shown). In either case, the memory is located externally to a processing circuit that is being reprogrammed, such as an electronic control unit (ECU) as shown below in FIGS. 4A-4B.

In certain embodiments, the amount of original memory saved can be dependent upon the length of the boot sequence to be programmed into the location from which the original memory is stored (i.e. the backup sector or sectors). The length of the boot sequence can be known by the reprogramming system, which will reserve sufficient memory to allocate space for a full alternate boot sequence. For example, if the boot sequence is longer than a single sector of memory, multiple sectors may be saved by the save module 104.

Operational flow proceeds to a boot storage module 106. The boot storage module 106 stores a boot sequence in at least a portion of the memory at the location from which the original memory contents are stored (i.e. the backup sector). The memory location selected can be at least partially within the backup sector and can encompass additional sectors as well, depending upon the length of the boot sequence.

Operational flow proceeds to a memory designation module 108. The memory designation module 108 designates the backup sector or sectors as a valid boot location. In one possible embodiment, a reset configuration half word stores the boot location for the system, and can be modified, for example, by the programmable circuit or the reprogramming system. The reset configuration half word is a predetermined memory location which stores a referencing memory address which points to the location of the system boot sector. The reset configuration half word can be two bytes holding a 16 bit memory location used to point to the location of a valid boot sector. Depending upon methodology, the memory location designation could be a memory address, sector index, or other memory location indicator. Other boot designation methodologies can be used as well.

Operational flow proceeds to a reprogram module 110. The reprogram module 110 is configured to store a new boot sequence in the original boot memory. In various embodiments, the boot sequence stored in the backup sector by the boot storage module 106 can be the original boot sequence in the original boot memory, can be the new boot sequence stored in the original boot memory by the reprogram module 110, or can be some other boot sequence.

Operational flow proceeds to a second memory designation module 112. The memory designation module 112 designates the original boot memory location as a valid boot location. In systems allowing only one boot location, the memory designation module 112 can also designate the backup boot sector as an invalid boot location in the memory when the original boot memory location is redesignated as a valid boot location. Like in the memory designation module 108, a reset configuration half word may be used to designate the location of the boot memory. The reset configuration half word may be used to designate the backup sector as an invalid boot sector at the same time as or after the designation of the original boot memory.

Operational flow proceeds to a memory restoration module 1114. The memory restoration module 114 restores the memory in the backup sector as well as other sectors whose contents were stored by the boot storage module 106 so that a boot sequence could be written to those locations. Operational flow terminates with an end operation 116.

Referring now to FIG. 2, a block diagram of a generalized electronic control unit 200 is shown that can be used to implement aspects of the present disclosure. The electronic control unit 200 includes a programmable circuit, shown as processor 202, and a memory subsystem, shown as memory 204. The programmable circuit can be any of a number of programmable gate arrays, programmable logic arrays, or portions thereof. The programmable circuit can also be any of a number of processors, such as embedded processors and socketed processors used in personal computing and server applications.

In a particular embodiment of the present disclosure, the processor 202 is a Freescale “Snake” embedded processor, which includes a NEXUS port for external communications. However, alternative processors or programmable circuits can be used as well.

The memory subsystem 204 can include one or more memory devices, and generally includes one or more nonvolatile memory devices. The nonvolatile memory device or devices used will be a matter of design choice, but in a preferred configuration, an erasable and programmable flash-ROM is used as at least part of the memory subsystem. The flash-ROM is a device that does not require power to be applied to maintain data integrity and storage, and is therefore a popular choice for boot sector memory that must be preloaded for use upon initialization of the electronic control unit 200.

Referring now to FIG. 3, the logical organization of a memory sector 300 is shown in a memory subsystem that can be used in an example embodiment of the present disclosure. The memory sector 300 includes a plurality of data storage locations 302. The data storage locations are each referenced by a memory location 304. The memory locations 304 shown are in hexadecimal format, and represent the low eight bits of the memory address within the sector. Each memory address 304 in the memory sector 300 references a word length portion of the memory, which is generally understood to include either two or four bytes of data, depending upon the processor or programmable circuit referencing the memory location. In the present disclosure, it is assumed that a word length memory location refers to four bytes of data, or 32 bits of data on most modern computing systems. Of course, other memory subsystem structures are possible having differing memory addressing granularities and/or capabilities.

In some specific memory subsystems, read and write operations occur on a per sector basis. In other words, the memory subsystem is accessed in large “chunks” of data which the processor or other programmable circuit uses to perform various functions (i.e. both instruction and data memory). In the case of memory sector 300 shown, eight bit addressing results in a sector size of one kilobyte. The one kilobyte sector size corresponds to 256 different addresses of data words multiplied by 4 bytes per data word.

In memory subsystems accessed on a per sector basis, it may be advantageous to erase an entire sector of memory, such as to ensure data programming accuracy and memory usage in subsequent read/write operations. Erasing the sector can be accomplished in a number of ways, depending upon the configuration of the memory. In one possible embodiment, an “erased” state is represented as a logical “1” written into each memory location. In such a system, the memory subsystem or processor can sequentially write a logical “1” into the memory locations, such as 0xFF, 0xFE, 0xFD, etc. In a second possible embodiment, an “erased” state is represented as a logical “0” written into each memory location. In these systems, a logical “0” is sequentially written into the memory locations, such as 0x00, 0x01, 0x02, and onwards until the sector write is complete.

Referring now to FIG. 4, the logical organization of a memory subsystem 400 is shown that can be used in an example embodiment of the present disclosure. In the memory subsystem shown, a plurality of sectors 402 are incorporated such that a unified memory hierarchy is formed. Each sector 402 is defined by a uniform and unique range of memory locations. The exemplary memory subsystem 400 includes 12 bits for memory addressing, reflecting 4 kilobytes of memory. A higher number of memory addressing bits will allow for a larger amount of addressable memory 400.

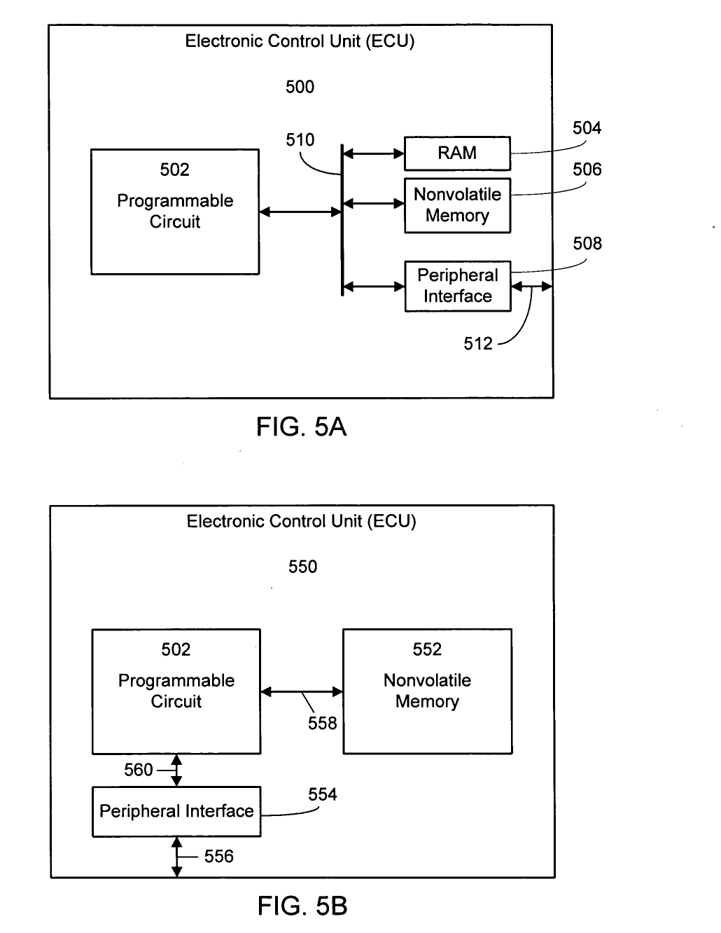

In the memory subsystem 400, one sector 402 can be designated as a proper boot sector. For example, the sector at 0x000 to 0x0FF could be considered the boot sector, and can incorporate initialization procedures and a bootstrap instruction. The remaining sectors, representing memory addresses 0x100 to 0xFFF, can include instruction memory and data memory, and can be used to define the specific operation of the processor interfaced with the memory subsystem 400. One of these remaining sectors can be allocated as the backup sector referred to above in FIG. 1, and can have its memory contents stored externally from the memory subsystem 400. In this way, the memory subsystem can have two sectors including boot data during a reprogramming process while preserving the data in the backup sector by storing the data with a reprogramming system, as shown below in FIGS. 5A-B.

Referring now to FIGS. 5A and 5B, block diagrams of two possible programmable circuits incorporating an electronic control unit (ECU) are shown in which aspects of the present disclosure can be implemented. Although the figures show two possible embodiments of such electronic control units, these figures are meant to be illustrative of the various interconnections utilized by the ECU's of the present disclosure, and are not intended to provide exhaustive functional definitions of such units.

FIG. 5A depicts an electronic control unit 500 including a programmable circuit 502 interfaced to random access memory 504, nonvolatile memory 506, and a peripheral interface 508 via a system bus 510. The structure of FIG. 5A can be used in systems in which the programmable circuit 502 has a single input/output data bus. The programmable circuit 502 can include any of a number of programmable logic devices or processing units, such as embedded processors provided by Freescale Semiconductor Corporate, Via Technologies, Intel Corporation, Advanced Micro Devices, or other processor manufacturers.

The random access memory 504 and nonvolatile memory 506 can provide a unified memory model as described above in connection with FIGS. 3-4, or can provide various other types of memory models known in the art. It is understood that the random access memory 504 shown can be incorporated in the electronic control unit 500, but is preferably not used for storage of boot sector data in conjunction with the methods and systems described herein for reprogramming nonvolatile memory, because a power failure would cause any memory storage within the random access memory 504 to be lost, limiting the effectiveness of the system as described herein.

The peripheral interface 508 can be implemented as a direct wired connection between the system bus 510 and external communication interface 512, or can include a receiver/transmitter arrangement for managing bus traffic, such as a universal asynchronous receiver/transmitter for communication to components external to the electronic control unit 500. A wireless arrangement can also be used in conjunction with a receiver/transmitter arrangement. The system bus 510 provides interconnections between the programmable circuit and the components with which it communicates. The peripheral interface can be a NEXUS interface, a controller area network (CAN), an ethernet network, or other communications controller or connection.

FIG. 5B shows a block diagram of a possible electronic control unit 550 in which aspects of the present disclosure can be implemented. The electronic control unit 550 incorporates a programmable circuit 502 and nonvolatile memory 552. The electronic control unit 550 further includes a peripheral interface 554 and an external communication interface 556, which can be similar to that shown in FIG. 5A.

The programmable circuit 502 can be any of a number of processors or programmable devices configurable to use multiple data buses. The system shown uses a first data bus 558 for communication to the nonvolatile memory 552 and a second data bus 560 for communication to the peripheral interface 554.

The nonvolatile memory 552 provides the entire memory subsystem of the electronic control unit 550. It is understood that the nonvolatile memory can include one or more memory components, such as flash memory or other nonvolatile memory as referred to above.

The peripheral interface 554 is configured to electrically connect directly to the programmable circuit 502, such as through use of a dedicated pin, port, or bus on the programmable circuit. The peripheral interface provides communication external to the electronic control unit 550 via the external communication interface 556.

Referring now to FIGS. 6A-6B, block diagrams of a memory reprogramming system used with a programmable circuit are shown according to possible embodiments of the present disclosure. The configuration shown in FIG. 6A illustrates the possible interfacing of the reprogramming system 604 with a system configured similar to that shown in FIG. 5A. Conversely, FIG. 6B illustrates a connection between a reprogramming system 604 with a system 652 similar to that shown in FIG. 5B.

In both figures, the reprogramming system 604 includes a controlling mechanism, such as a personal computer or other computing system, and an interface configured to communicate with one or more embodiments of the electronic control unit 602, 652. The interface within the reprogramming system 604 can be a complementary interface to those described above as incorporated within the electronic control units contemplated by the present disclosure.

In the configuration shown in FIG. 6A, an interface 612 connects to a system bus 610, which in turn is connected to the programmable circuit 606 and memory 608 within the electronic control unit 602. In the configuration shown in FIG. 6B, an interface 654 connects directly to a programmable circuit 606 independent of a communication channel to the memory 608. Either interface 612, 654 can include a peripheral interface unit such as those described above in FIGS. 5A-5B (i.e. ethernet, NEXUS, K-Line, controller area network, or other interface protocol/hardware).

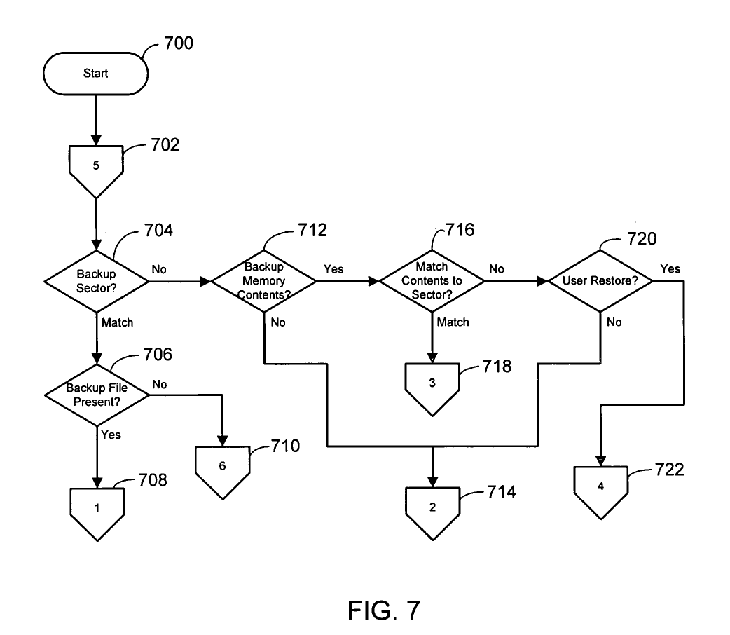

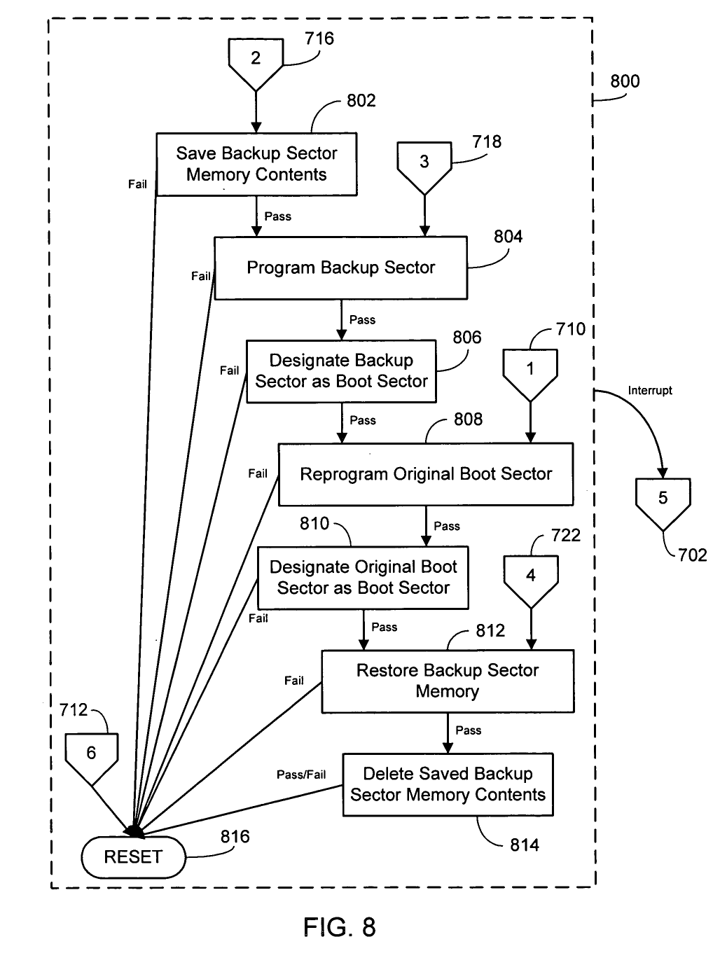

Referring generally to FIGS. 7-8, logical flow diagrams of systems and methods for recovery from failures in programming nonvolatile memory are shown. The systems and methods as described provide one possible embodiment of the present disclosure, and can be implemented as a software product, a computerized method, or hardware/software combination in one or more of the various hardware configurations as described above.

Referring now to FIG. 7, a logical flow diagram of failure determination aspects of methods and systems used in recoverable reprogramming of a nonvolatile memory according to an example embodiment of the present disclosure is illustrated. The failure determination aspects are shown as a failure determination system 700, which, in general, is configured to interface with a system such as the one shown in FIG. 8 to determine whether a nonvolatile memory reprogramming attempt is successful, and to locate the earliest occurring failure within the reprogramming process so as to determine what corrective action is required.

The failure determination system 700 is instantiated by a start operation 700. Operational flow proceeds through an interrupt feedback link 702, which allows for restarting system 700 in case of an interrupt in the recoverable reprogramming system shown in FIG. 8. The feedback link 702 and other links described in connection with FIG. 7 are interfaces to operational aspects of a system, such as that illustrated in FIG. 8.

Operational flow proceeds to a backup operation 704. The backup operation 704 determines whether a copy of the data originally stored in a backup sector have been stored in a reprogramming system, such as the reprogramming system 604 described above in conjunction with FIGS. 6A and 6B. If the backup operation 704 determines that the data stored by the reprogramming system match the memory contents in the backup sector, operational flow branches “match” to a backup operation 706.

The backup operation 706 determines the existence of the file containing the data stored by the reprogramming system that was originally stored in the backup sector. If the backup operation 706 determines that the file is present where stored, operational flow branches “yes” to a reprogram feedback link 708. If the backup operation 706 determines that the file is not present where stored, the system 700 determines that the file has been erased and operational flow branches “no” to a reset feedback link 710.

If the backup operation 704 determines that the data stored by the reprogramming system does not match the memory contents in the backup sector, operational flow branches “no” to a data detection operation 712. The data detection operation 712 detects the presence of the data stored in the reprogramming system that was originally stored in the backup sector. If the data detection operation 712 determines that the data is not present where stored, operational flow branches “no” to a save feedback link 714. If the data detection operation 712 determines that the data is present where stored by the reprogramming system, operational flow branches “yes” to a match operation 716.

The match operation 716 determines whether the contents of the backup sector matches the data stored in the reprogramming system that was originally stored in the backup sector. If the match operation 716 determines that the data matches, operational flow branches “match” to a program feedback link 718. If the match operation 716 determines that the data does not match, operational flow branches “no” to a restore operation 720.

The restore operation 720 determines whether the backup sector data is restored successfully from the reprogramming system. If the restore operation 720 determines that the backup sector data is not restored correctly, operational flow branches “no” to the save feedback link 714. If the restore operation 720 determines that the backup sector data is restored correctly, operational flow branches “yes” to a restore feedback link 722.

The feedback links, including the interrupt feedback link 702, the reprogram feedback link 708, the reset feedback link 710, the save feedback link 714, the program feedback link 718, and the restore feedback link 722, provide an interface to operational aspects of a system for recoverable reprogramming of nonvolatile memory according to the present disclosure. One possible system capable of interfacing with the failure determination system 700 is shown below in conjunction with FIG. 8.

FIG. 8 shows a system 800 for performing recoverable reprogramming of a nonvolatile memory according to an example embodiment of the present disclosure. The embodiment shown can interface with the flow diagram of FIG. 7 due to the feedback links 702, 710, 714, 718, 722 as described above.

Preferably, the system 800 is tolerant of various types of interruptions, such as a power failure or other recoverable error. The system 800 is interfaced with an interrupt feedback link 702 interfaced with the flow diagram of FIG. 7 such that upon occurrence of a system interrupt, the failure determination operations shown therein are performed to determine the specific point at which the failure occurred. The system 800 further preferably includes a number of feedback links to an error determination system, such as the one shown in FIG. 7, to determine the last successful reprogramming step which has occurred. By determining the point at which the failure occurred, the system 800 can continue operation from that point so as to recoverably reprogram the nonvolatile memory of the system, including any boot sector memory that may need to be reprogrammed.

Operational flow in the system 800 is instantiated via an interface to the one or more feedback links which may be included. The system 800 can be performed using a reprogramming system such as the one shown above in FIGS. 6A-6B, in conjunction with an electronic control unit as has also been previously described.

Operational flow proceeds within system 800 to a save module 802 via a save feedback link 714. The save module 802 saves the contents of at least one backup sector in the memory subsystem. In various embodiments of the present disclosure, the save module 802 can be performed by a reprogramming system, and can store the contents (i.e. data) of the backup sector in a memory external to the electronic control unit. In one embodiment, the memory external to the electronic control unit is included in the reprogramming system.

In the system shown, the backup sector can be any sector within memory that is not to be reprogrammed by the reprogramming system. Generally, the backup sector will be a non-boot sector within nonvolatile memory in the memory subsystem.

The save module 802 verifies that the data from the backup sector is stored correctly. If the data is stored correctly, operational flow proceeds to a program module 804. Operational flow can also proceed within system 800 directly to the program module 804 via a program feedback link 718. This may be the case, for example, if a system failure occurs after a store module operation occurs successfully. If the data is not stored correctly, operational flow proceeds to a reset module 816, described below.

The program module 804 programs the backup sector with a boot sequence, such as the original or updated boot sequence for the electronic control unit. The program module 804 may program additional sectors with portions of the boot sequence, depending upon the size of each sector and the length of the boot sequence. The boot sequence can include initialization and bootstrap instructions for setup of an electronic control unit.

In an example embodiment, the program module 804 erases the backup sector or sectors prior to programming the boot sequence. For example, the program module can use the per sector erase process described above in conjunction with FIG. 3-4.

The program module 804 also verifies that the boot sequence is properly programmed. If the boot sequence is properly programmed, operational flow proceeds to a designation module 806. If the boot sequence is not properly programmed, operational flow proceeds to the reset module 816, described below.

It is noted that during operation of the save module 802 and the program module 804 the original boot sector is denoted as the valid boot sector of the electronic control unit. However, in instances where the original boot sector must be reprogrammed such as to update the boot sequence, a second boot sector can be used to ensure that a “brain dead” state does not occur wherein the electronic control unit cannot recover from an unpredicted system failure.

The designation module 806 designates the backup sector, and potentially additional sectors depending upon the length of the boot sequence, as a valid boot sector or sectors. The designation module 806 can write this designation to a reset configuration half word, provide a memory address of the sector to a reserved register, or use some other boot designation method depending upon the electronic control unit used. Following operation of the designation module 806, boot operation passes to the backup module within the electronic control unit, and bypasses the original boot sector. This allows the system to reliably reprogram the original boot sector while maintaining a second boot sector in case of a power outage or other unpredicted failure. The designation module 806 determines whether the backup sector is properly designated as a boot sector. If the sector is properly designated, operational flow proceeds to a reprogram module 808. If the sector is properly designated, operational flow proceeds to the reset module 816.

The reprogram module 808 provides reprogramming to the original boot sector or other sectors within the nonvolatile memory in the memory subsystem. The reprogram module 808 is managed by the reprogramming system, and can be used to update the boot sequence stored in the original boot sector. Operational flow can also proceed within system 800 directly to the reprogram module 808 via a reprogram feedback link 708.

As discussed in conjunction with the program module 804, the reprogram module 808 can optionally include an erase operation, such as the per sector erase process described above. Of course, both the use of and the type of erase process used in both the program module 804 and the reprogram module 808 is dependent upon the implementation of system 800 as well as the configuration of the memory subsystem and electronic control unit used.

The reprogram module 808 determines whether the original boot sector and other sectors that are affected have been successfully reprogrammed. If the reprogramming is successful, operational flow proceeds to a second designation module 810. If the reprogramming is unsuccessful, operational flow proceeds to the reset module 816.

The second designation module 810 designates the original boot sector as a valid boot sector. Following operation of the designation module 810, boot operation returns to the original boot sector within the electronic control unit, and no longer requires usage of the backup sector. Therefore, the designation module 810 can optionally also designate the backup sector as an invalid boot sector. The designation module 810 also determines whether the designation of the original boot sector as a valid boot sector is successful. If the designation occurs successfully, operational flow proceeds to a restore module 812. If the designation is unsuccessful, operational flow proceeds to the reset module 816.

Operational flow can also proceed within system 800 directly to the restore module 812 via a restore feedback link 722. The restore module 812 restores the backup sector data into the backup sector via the reprogramming system. The restore module 812 stores the data that is held external to the electronic control unit back into the memory subsystem and in the backup sector. In this way, the electronic control unit can hold a backup copy of a boot sequence while only temporarily using additional memory from the memory subsystem. The restore module 812 determines whether the backup sector data held by the reprogramming system is successfully restored in the backup sector. If the restoration process is successful, operational flow proceeds to a deletion module 814. If the restoration process is unsuccessful, operational flow proceeds to the reset module 816.

The deletion module 814 deletes the backup sector data from the reprogramming system, signifying that the backup sector has been successfully restored. The reprogramming system can use the absence of backup sector data as an indicator that the process has successfully completed. The deletion module determines whether this deletion process has been completed successfully. Operational flow proceeds to the reset module 816.

Operational flow proceeds to the reset module 816 from the other modules in the system as described above, as well as directly from a reset feedback link 710. The reset module 816 restarts the electronic control unit. If a failure has occurred in the system during reprogramming of the nonvolatile memory, one or more of the operations of FIG. 7 will detect the failure after the reset operation and pass operational flow to the appropriate location in the system 800.

Two examples can best illustrate operation of the system of FIGS. 1-8 as applied specifically to a boot reprogramming sequence for a computing system, such as the electronic control unit of FIG. 5A-B. In a successful boot reprogramming sequence, the system performs only the steps described in FIG. 1 or FIG. 8 or some other equivalent methodology. Using the system 800 of FIG. 8 as an example, the save module 802 saves data from the backup sector. The program module 804 stores the boot sequence in the backup sector using a program module 804. The designation module 806 designates the backup sector as the valid boot sector. The reprogram module 808 reprograms the original boot sector. The designation module 810 designates the original boot sector as the valid boot sector. The reprogram module 812 can optionally restore the data to the backup sector from the reprogramming system. The deletion module 814 can delete the saved backup memory contents.

Errors may occur during the reprogramming, such as due to hardware, software, or external failure conditions. In such a case, the operations of FIG. 7 can be sequentially completed upon a system reset or interrupt sequence to determine the earliest point in the reprogramming process at which an error occurred. By determining the portions of the system containing boot sequence and/or data files, it is possible to determine what steps have been accomplished in the reprogramming process.

Referring back to FIGS. 7 and 8, a second example is discussed where a power failure occurs during operation of the reprogramming module 808. In such a case, modules 802, 804, and 806 have executed successfully prior to the power failure, and the backup sector is designated as the currently valid boot sector, such as by writing the reset configuration half word. So, the electronic control unit (ECU) has a valid boot sector, and can be operated normally despite the power failure during the reprogramming process. Upon resetting the ECU, the test operations of FIG. 7 execute. The backup sector operation 704 compares the original contents of the backup sector to the expected data from the backup sector, and determines that the backup sector data was properly saved. Operational flow branches “match” to the backup operation 706. The backup operation determines that the backup file is present in the reprogramming system, denoting that the file has not been manually removed. Operational flow branches “yes” to the reprogram feedback link 710.

The reprogram feedback link 710 can interface with the system 800 of FIG. 8 to continue the reprogramming process at the reprogram module 808. At this point, operational flow proceeds to the designate module 810, to the restore module 812, and to the deletion module 814 to complete the process as described above.

Depending upon the timing of the power outage in the example, operational flow through FIGS. 7-8 will vary. For example, if the power outage occurs during operation of the restore module 812, operational flow in FIG. 7 will proceed through modules 704, 712, 714, 720 to the restore feedback link 722. Operational flow then proceeds to the restore module 812 of FIG. 8 for completion of the remaining module in the reprogramming process which has not yet successfully completed operation.

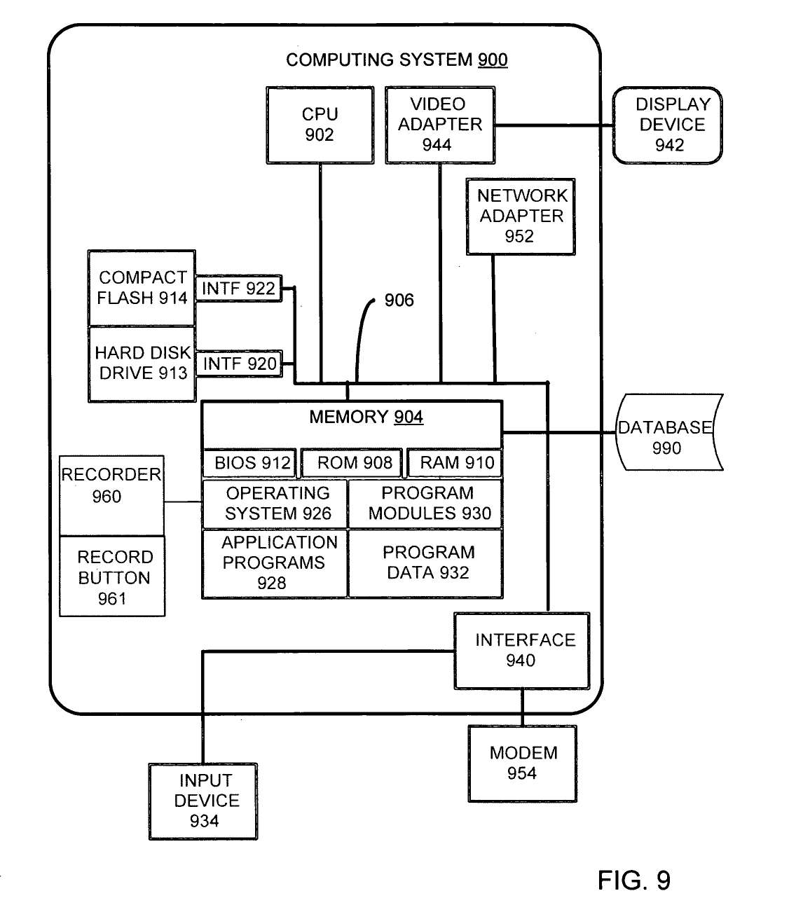

Referring now to FIG. 9, a generalized computing system 900 is shown in which aspects of the present disclosure can be implemented. The computing system 900 can be, for example, the system being reprogrammed (the “electronic control unit” as described above), or can serve as the reprogramming system. FIG. 9 and the corresponding discussion are intended to provide a brief, general description of a suitable computing environment in which the invention might be implemented. Although not required, the disclosure is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

FIG. 9 shows an exemplary environment for implementing embodiments of the present invention, and includes a general purpose computing device in the form of a computing system 900, including at least one processing system 902. A variety of processing units are available from a variety of manufacturers, for example, Intel or Advanced Micro Devices. The computing system 900 also includes a system memory 904, and a system bus 906 that couples various system components including the system memory 904 to the processing unit 902. The system bus 906 might be any of several types of bus structures including a memory bus, or memory controller; a peripheral bus; and a local bus using any of a variety of bus architectures.

Preferably, the system memory 904 includes read only memory (ROM) 908 and random access memory (RAM) 910. A basic input/output system 912 (BIOS), containing the basic routines that help transfer information between elements within the computing system 900, such as during start up, is typically stored in the ROM 908.

Preferably, the computing system 900 further includes a secondary storage device 913, such as a hard disk drive, for reading from and writing to a hard disk (not shown), and/or a compact flash card 914.

The hard disk drive 913 and compact flash card 914 are connected to the system bus 906 by a hard disk drive interface 920 and a compact flash card interface 922, respectively. The drives and cards and their associated computer readable media provide nonvolatile storage of computer readable instructions, data structures, program modules and other data for the computing system 900.

Although the exemplary environment described herein employs a hard disk drive 913 and a compact flash card 914, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 913, compact flash card 914, ROM 908, or RAM 910, including an operating system 926, one or more application programs 928, other program modules 930, and program data 932. A user may enter commands and information into the computing system 900 through an input device 934. Examples of input devices might include a keyboard, mouse, microphone, joystick, game pad, satellite dish, scanner, digital camera, touch screen, and a telephone. In the exemplary computing system, these and other input devices are often connected to the processing unit 902 through an interface 940 that is coupled to the system bus 906. These input devices also might be connected by any number of interfaces, such as a parallel port, serial port, game port, or a universal serial bus (USB). A display device 942, such as a monitor or touch screen LCD panel, is also connected to the system bus 906 via an interface, such as a video adapter 944. The display device 942 might be internal or external. In addition to the display device 942, computing systems, in general, typically include other peripheral devices (not shown), such as speakers, printers, and palm devices.

When used in a LAN networking environment, the computing system 900 is connected to the local network through a network interface or adapter 952. When used in a WAN networking environment, such as the Internet, the computing system 900 typically includes a modem 954 or other means, such as a direct connection, for establishing communications over the wide area network. The modem 954, which can be internal or external, is connected to the system bus 906 via the interface 940. In a networked environment, program modules depicted relative to the computing system 900, or portions thereof, may be stored in a remote memory storage device. It will be appreciated that the network connections shown are exemplary and other means of establishing a communications link between the computing systems may be used.

The computing system 900 might also include a recorder 960 connected to the memory 904. The recorder 960 includes a microphone for receiving sound input and is in communication with the memory 904 for buffering and storing the sound input. Preferably, the recorder 960 also includes a record button 961 for activating the microphone and communicating the sound input to the memory 904.

A computing device, such as computing system 900, typically includes at least some form of computer-readable media. Computer readable media can be any available media that can be accessed by the computing system 900. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 900.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

One skilled in the art would recognize that the system described herein can be implemented using any number of software configurations, network configurations, hardware configurations, and the like.

The logical operations of the various embodiments illustrated herein are implemented (1) as a sequence of computer implemented steps or program modules running on a computing system and/or (2) as interconnected logic circuits or circuit modules within the computing system. The implementation is a matter of choice dependent on the performance requirements of the computing system implementing the invention. Accordingly, the logical operations making up the embodiments of the present invention described herein are referred to variously as operations, steps, or modules.

The above specification, examples and data provide a complete description of the manufacture and use of the composition of the invention. Since many embodiments of the invention can be made without departing from the spirit and scope of the invention, the invention resides in the claims hereinafter appended.

1. A method of reprogramming a nonvolatile memory having a plurality of sectors including a backup sector, the method comprising:
saving original backup sector memory contents of the backup sector;
storing a boot sequence in the backup sector;
designating the backup sector as a valid boot sector;
reprogramming at least one sector in the nonvolatile memory, the at least one sector separate from the backup sector;
designating a sector separate from the backup sector as a valid boot sector;
storing the original backup sector memory contents in the backup sector.

2. The method of claim 1, further comprising:
(a) restoring the original backup sector memory contents into the backup sector.

3. The method of claim 1, wherein:
(a) storing the boot sequence includes storing an updated boot sequence.

4. The method of claim 1, wherein:
(a) storing the boot sequence includes storing an original boot sequence.

5. The method of claim 1, wherein:
(a) reprogramming at least one sector includes reprogramming an original boot sector.

6. The method of claim 1, wherein:
(a) designating a sector as a valid boot sector includes designating an original boot sector as a valid boot sector.

7. The method of claim 1, further comprising:
(a) upon saving original backup sector memory contents from the backup sector, erasing the contents of the backup sector.

8. The method of claim 1, wherein:
(a) designating the backup sector as a valid boot sector includes writing a reset configuration memory location.

9. The method of claim 1, further comprising:
(a) upon designating a sector separate from the backup sector as a valid boot sector, designating the backup sector as an invalid boot sector.

10. The method of claim 1, further comprising:
(a) upon detection of a failure, comparing the memory contents of the backup sector to the boot sequence.

11. The method of claim 10, further comprising:
(a) upon comparing the memory contents of the backup sector to the boot sequence to determine that the backup sector includes the boot sequence, detecting the original backup sector memory contents.

12. The method of claim 11, further comprising:
(a) upon detecting the original backup sector memory contents, detecting a failure that occurred while reprogramming the at least one sector.

13. The method of claim 12, further comprising:
(a) upon detecting the failure, determining the last successful reprogramming step completed.

14. A system for reprogramming a nonvolatile memory, the system comprising:
an electronic control unit including:
a nonvolatile memory including a plurality of sectors, the plurality of sectors including a backup sector;
a programmable circuit electrically connected to the nonvolatile memory, the programmable circuit configured to initialize by accessing a boot sector in the nonvolatile memory; and
a reprogramming system electrically connected to the electronic control unit, the reprogramming system configured to:
save original backup sector memory contents of a backup sector;
store a boot sequence in the backup sector;
designate the backup sector as a valid boot sector;
reprogram at least one sector in the nonvolatile memory, the at least one sector separate from the backup sector; and
designate a sector separate from the backup sector as a valid boot sector.

15. The system of claim 14, wherein:
(a) the reprogramming system is further configured to restore the original backup sector memory contents in the backup sector.

16. The system of claim 14, wherein:
(a) the boot sequence is an updated boot sequence.

17. The system of claim 14, wherein:
(a) the boot sequence is an original boot sequence.

18. The system of claim 14, wherein:
(a) the reprogramming system is configured to, upon detection of a failure, compare the memory contents of the backup sector to the boot sequence.

19. The system of claim 18, wherein:
(a) the reprogramming system is configured to, upon comparing the memory contents of the backup sector to the boot sequence to determine that the backup sector includes the boot sequence, detect the original backup sector memory contents.

20. The system of claim 19, wherein:
(a) the reprogramming system is configured to, upon detecting the original backup sector memory contents, detect a failure that occurred while reprogramming the at least one sector.

21. The system of claim 20, wherein:
(a) the reprogramming system is configured to, upon detecting the failure, determine the last successful reprogramming step completed.

22. A method of reprogramming a boot sequence in a nonvolatile memory having a plurality of sectors including a backup sector, the method comprising:
saving an original backup sector memory image from the backup sector;
upon saving the original backup sector memory image, erasing the contents of the backup sector.
storing a boot sequence in the backup sector;
designating the backup sector as a valid boot sector;
designating an original boot sector in the nonvolatile memory as an invalid boot sector;
reprogramming the original boot sector with a new boot sequence;
designating the original boot sector as a valid boot sector;
designating the backup sector as an invalid boot sector;
storing the original backup sector memory image in the backup sector.

23. The method of claim 22, further comprising:
(a) upon detecting a failure, determining the location of the failure.
